(19) United States
(12) Patent Application Publication
(10) Pub. No.: US 2021/0049524 A1
(43) Pub. Date: Feb. 18, 2021

(54) CONTROLLER SYSTEM FOR LARGE-SCALE AGILE ORGANIZATION

(71) Applicant: Dr. Agile LTD, Tel-Aviv (IL)

(72) Inventors: Ofer NACHUM, Kiryat-Tivon (IL); Nela GUREVITCH, Yokneam Ilit (IL); Dror ZERNIK, Haifa (IL)

(73) Assignee: Dr. Agile LTD, Tel-Aviv (IL)

(21) Appl. No.: 16/943,104

(22) Filed: Jul. 30, 2020

Related U.S. Application Data
(60) Provisional application No. 62/880,692, filed on Jul. 31, 2019.

(51) Int. Cl. G06Q 10/06; G06Q 10/10; G06K 9/62; G06N 20/00

(52) U.S. Cl. CPC G06Q 10/067; G06Q 10/0633; G06N 20/00; G06K 9/6256; G06Q 10/103

(57) ABSTRACT

According to an aspect of some embodiments of the present invention there is provided a computerized method for generating a system which can be used either as a control system or as a simulator, of an agile organization of scale (more than a single Agile team). The method may comprise of receiving a training dataset having records, describing a combination of organization structure, and business goals. Each business goal-record may be split into smaller activities comprising tasks which are added to the simulation backlog.

The method may further include records for specific events which may occur during the following time-box period. The users of the computerized method may choose from a variety of responses which reflect managerial decisions in a Scaled Agile organization, such as prioritizing activities, or slight modifications to the organization structure, or altering existing processes. Alternatively, these decisions can be automatically generated by the system, in which case the system can become a control system, providing Agile managerial assistance.

The goal of the decisions is to improve the completion of tasks from the business goals, thus earning business value, or money. At the same time, the system should provide capabilities to improve the predictability of meeting the committed plans per Timebox, Sprint or Program Increment.

The method may further include various reporting dashboards which are commonly used in Agile organizations, including team-level and ART level or multiple ARTs level.

The method further includes a learning-work-model which automatically improves using machine-learning techniques. The input for this model are the various aspects of the operational model of the organization, and are based on data collected from the various organization's operational systems.

### BACKGROUND

The present invention, in some embodiments thereof, relates to a method and system for improving the organization's Agile working model based on operational data collected (or sampled, possibly in real time and/or periodically e.g. daily) by various “agents” or “sensors”, from various business operational systems (e.g. emailing system, task management/work flow system, finance/budget control system etc.).

In its full operation, the system can be used for controlling and assisting in enforcing organization Agile policies. Alternatively, it can be used also for predicting the execution of the organization in the next quarter (Super-sprint or Program Increment) in order to ensure higher degree of predictability and risk reduction, by using what-if scenarios.

A third usage of the system, is to use it as a synthetic simulator, running a close enough model of the organization.

When used as a control system, the system can be used for realizing the ‘manufacturing constraints’ and bottlenecks of the existing organization. The system can be used in various ways, such as automatically altering and controlling the utilization of the bottleneck services; recommending team-forming changes; automatic prioritization of projects and tasks; adding or removing scope to a plan, and additionally a training environment of a team of professional managers either preparing for the Large Scale Agile transformation, or considering organizational changes or any other improvements during the course of the scaled agile journey.

The data collected/sampled by the sensors/agents could potentially be very detailed and in large volumes (aka big-data) and will be used as input for automatic analysis of patterns, learning, and improvements of the organization operating model. The data is further analyzed by a learning-engine, which keeps tracking correlations, and using previously acquired data in order to detect, suggest and, if necessary, automatically enforce, if required, the improved operational models. In the context of a training environment, these alternative models are provided as probable suggestions for managers during their simulation sessions, or training sessions. Alternatively, the reporting systems which are a part of the system, or use third party reporting tools, can expose the new, optimized models.

As used herein, the terms/phrases Agile, Lean, LeSS, SAFe, Scrum, and Kanban mean various methods for implementing the Agile methodology within an organization. Agile is a rapidly accepted methodology, a way of thinking, and a common practice for working in complex environments such that are common in the modern work environments. It assumes that processes and goals must be rapidly adjusted in order to ensure the survival and competitive edge of the business or organization.

In its simple version, Agile is adopted for the team level, aiming at improving most of the common Key Performance Indicators (KPI) including: Predictability, Quality, coordination between Business and IT and the Team's Moral.

For the team level, various simulation techniques were evolved, including board-games, computerized simulations and more. These typically are used to show the nature and decisions which are required by the team and its immediate leadership to achieve the desired impacts. These implementations were configured as synthetic, theoretical cases, not related to the actual operational systems. Further, they did not have any way of intervening with the executable process.

Those simulations relied first on a mathematical model, which represents the various parameters which impacted a successful application of the Agile methodology at a team level. These parameters typically include: the team size and specialized skills of each member, the Timebox (referred to as Sprint length), and the size-distribution and quantity of work-items selected during the simulation.

Those simulations had a static, fixed model, and a limited interaction with the actual events taking place in the organization, and no feedback capability—to impact the organization actual operation.

Forming a model of a large-scale Agile implementation is much more complex, and relies on abstracting beyond the team level. At this level, the KPIs are different, and include, typically: Time to Market (TTM), Customer Satisfaction, Alignment with organizational initiatives, meeting regulatory requirements, and more. Further, forming a model relies, on top of the team-level parameters, on additional parameters: a. modeling several teams, b. the cross-team relationships/dependencies c. the size, partition and distribution of larger work-items (features, or projects—in the Agile language this is referred to as the backlog) between the teams, and d. the size of the “super-sprint”, or the major release or larger Timebox which all the teams aim at synchronizing at.

Such a formal modeling has not been done, to the best of our knowledge, so far, for various reasons: Simulation of a larger organization is harder, as inherently in the Agile thinking, teams have a higher degree of ownership, and while predictability is achieved, the synchronization mechanisms are subtler, and thus harder to model. The attempt to form such a model based on a formula, or a process seems useless; instead the system should use the gathered sensors data in order to provide the needed learning to continuously improve the model.

It seems obvious that any attempt to formalize such a model is doomed to fail. Instead, we propose to form an initial model, and to rely on machine-learning techniques which will refine the model, and will provide: a. a more accurate model of the real organization and processes b. will provide alternative improved model and c. will evolve over time, as new scenarios and constraints are gathered, or the reality of the organization changes. The newly acquired models can be shared with managers to experience, discuss and learn, and naturally, also to control the degree of changes with regard to the current organization model.

In order to be able to simulate a larger organization performance an initial scaling-up operational model needs to be selected. This should be based on one of the common scaling up practices. The most common are SAFe (Scaled Agile Framework), Scrum of Scrum, Disciplined Agile Delivery, LeSS (Large Scale Scrum), the Spotify Model, Nexus and some other models. The simulation is based on an abstraction model which summarizes the common principles of the selected relevant scaling techniques.

It is expected that based on the selected model the simulation would expose some control ‘knobs’ to the user, which allows for modifications of the model parameters. These modifications of the model parameters can be done either manually, or based on actual operational data collected by the agents/sensors from the operational systems (e.g. statistical characteristics of requests coming from customers, timing, types, sizes . . . ). Furthermore, the model should be refined and learning should be performed as more data is gathered from the sensors.

As mentioned before, few simulations exist for the team level, relying mostly on the Kanban flow model. These simulations typically do not even refer to a Timebox. To the best of our knowledge, there is no Scrum team simulator, let alone a multiple team simulator which “learns” and adjusts its configuration parameters based on actual operational data.

Since the Scaling-Agile methodology generates multiple constraints, non-standard organization structures and processes, and high degree of fluidity, and changes—the common organization simulations provide very little, if any, support in analyzing, forming and understanding the impacts of managerial decisions within the Agile framework, let alone, the ability to actually direct the organization to a newly derived model.

### SUMMARY

A simulation system is provided, which offers the participants (typically managers, or trainees, considering an implementation of Agile in their organization, or considering organizational changes or any other improvements as part of their existing agile journey) the ability to control the managed organization, using actual data and with relations to the operation of the organization. The system lets managers experience the impact of possible managerial decisions on the Agile organization performance. The system can automatically enforce many of the model's operational activities, or alternatively, turn them into alerts, or recommendations.

Typically, the simulator has an initial organization Agile model, and may use various sensors to acquire real-time behavioral data on the organization, and a learning engine, which keeps refining the internal model, and suggesting possible improvements to the model (translated to managerial decisions/actions). Managerial decisions can be fed into the simulation system either manually (reflecting managers' thoughts and beliefs as to how the system should better be modeled) and/or combined with simulation parameters generated automatically based on actual performance data collected by the various agents/sensors from the operational systems (for example—the agents/sensors can detect, from the task management system, that the average number of work items that a team is working on in parallel and suggest to reduce the number (aka WIP limit). Another example—the agents/sensors can detect, from the finance/budgeting control system that a project has just been approved, and based on previously learnt patterns, predict/forecast an increase in architecture work, and make a recommendation to add capacity within a known time to the architecture team).

In general, the system can detect and predict bottlenecks in the Agile production flow, and thus can either suggest or enforce alternative passes, or better utilization of the bottlenecks. It is important to note, that unlike standard manufacturing, where the operation of a machine, its throughput, and availability, including faults, are well analyzed and formalized, an Agile organization behaves like a manufacturing ‘many lines’ with little regularity. Therefore, the formal manufacturing management tools and processes (Production Management tools) cannot be used for formalizing an Agile organization.

The system is based on an initial configuration of the organization. This configuration is, optionally, a model for multiple Agile teams, represented by a configuration parameter set, describing the organization structure, number of teams, grouping of teams, supporting teams, and mode of operation (e.g. Scrum, Kanban, service teams, non-agile teams, etc.). Often, several basic information flows are already embedded in the project management tools, reflecting contributors and owners adding value to the complete product. Using the agents/sensors which monitor the various communication systems (e.g. emailing system, messaging systems etc.), the system can analyze the actual communication traffic, acquire the needed flows, identify clusters of people that communicate intensively, and make configuration recommendations, or form an alternative model, such that include the required people as early as needed, and specifically, in the Periodic (typically, quarterly) planning session.

An additional set of parameters, which are required for the model, includes the organizational synchronization clocks, known in Agile as Sprint (Interval) and Program Increment (a sequence of several Sprints, Super-Sprint).

Optionally, an additional parameter set exposes the quantitative decisions that the leadership group often is required to make during the development process or on-going operation. These decisions are exposed through a User Interface, and have impact on the progress of the development process in the successive time interval(s). Typically, these decisions include:

Reducing cross-team dependencies, by restructuring/splitting service teams

Reducing cross-team dependencies, by differently splitting or modifying the tasks

Re-balancing teams, to better fit new requirement and business needs

Adding synchronization processes, to ensure better alignment

Adding reporting dashboards, to enable better management control during the various time intervals.

All of the above decisions can either be automatically governed by the system, semi-automatically applied, or exposed to managers, so that they can consider them when necessary, e.g. during the quarterly planning process, or during a training session.

The challenges that a manager faces once Agile transformation is in place, are that although the flow and the mechanics are better understood, where to invest managerial attention and budget, is not always that intuitive. A sample of such challenges are:
1. Which team needs enforcement (e.g. adding 1 person)—and will improve the entire group's performance
2. Which flow restrictions (e.g. WIP limit) should be set, in order to improve cycle time (time-to-market). Hence, what should the manager instruct the group to refrain from doing, or where to focus the teams' attention.
3. How to change “policies” (who needs to review, who needs to participate)—to improve flow without sacrificing quality.
4. How much to invest in planning and prioritizing the backlog?
5. Whether to keep service teams separate and preserve the dependencies on them, or to upskill the development teams so that they can do the work themselves, without being dependent on the external service team.
6. How much to invest in governance tools and their assimilation into the process, and when to do that.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is an overall architecture of the suggested system. It suggests a separation between a User Interface module (No. 1 in the Figure) in which the various operations, and the new requirements, which the organization needs to meet in the coming intervals are displayed. A portion of the User Interface (see also Figure No. 8 and No. 9), is also initially used to configure the desired organizational structure: e.g. group of 5-8 teams, or multiple such groups; a single support-team, or multiple such teams; the type of dependencies between support teams and the groups, etc. (See FIG. 9, for dependency setting).

Once the organization's configuration is set, data acquisition also takes place. This can be achieved by either connecting to the relevant information systems Application Program Interfaces (API) or through other gates (e.g. mail database). This is used as an initial training set for defining the Machine-Learning-based model. The result of running the first iteration of learning is the initial model, which we will refer to as MO. MO is used by the simulation engine. It naturally refers to the organization goals which, in Agile, are described as a backlog, and are presented to the users. The goal of the simulation, is identical to the main goal of the organization, hence—to complete all of the initiatives/projects/features/which are stored in the backlog (No. 7).

In order to achieve this goal, the system or the managers need to decide several types of decisions: when using the system as a simulator/game, each time interval, (Sprint or Program Increment) the participants are allowed to take some decisions. When used as a semi-automatic control system, some of the required decisions may be carried out by the system itself, based on the understandings that were acquired by the improved model (will be referred to as Mi) which the Model Learning Engine (No. 6) has generated.

Based on the new mode, new decisions are required, for prioritization of tasks to meet goals; investment in preparation for tasks; investments in monitoring & governance; and additional alterations in team structures or work processes. These decisions are passed through the Simulation and Control Engine (No. 2) to the Model DB (No. 3) where they are stored.

Based on these parameters the next interval events are executed and recorded. These can be either generated by the simulation & control engine (No. 2) or based on events gathered from the operational systems (No. 5)—from the various sensors/agents. The gathering and recording is done by the Simulation & Control Engine (No. 2). When used as a simulator, the system than may feed timely events into Module No. 4, the Optional—third party event & reporting engine. When used as a control system, the required events may be fed into the Operational system (No. 5) control agents. These may cause activities, raise flags, or initiate some reviewing processes within the organization.

NOTE: in a preferred implementation, Module No. 4 is a standard Agile Management tool, such as Jira, Rally, TFS, Monday or VersionOne. (or the like). These tools provide Programming APIs, which record low level events (e.g. commitment by a team, moving a task during a Sprint, and completion of a task). These tools also provide a variety of reporting graphs & dashboards for the teams and for managers. By using such a tool, much of the recording and reporting becomes standard, and the main challenges remain within the other modules.

Module No. 5 is an additional set of agents/sensors which monitor the various operational systems, collect data which is further being used for automatic learning and improving the work model, by the model-learning engine (No. 6).

Module No. 6—is an ongoing learning engine which uses common machine-learning techniques in order to find correlations, patterns and predictors between the various events. Additionally, this learning engine may use common machine-learning techniques (e.g. genetic algorithms, classification methodologies, and predictive methods), in order to provide in order to provide an improved model M1 which performs better than the initial model M0, or later, to keep building new model sequences M(i+1) which outperforms the previous model Mi. Eventually, this learning engine should provide an alternative operational model, to be stored in the Model Database (3), which is used in the following sequence of time-box executions or the sequence of simulation stages by the Simulation & Control Engine (2).

Note that the Backlog database (No. 7) may include either a. manually configured work-items (initiatives, projects and features) (this must be the case when used as a control system), b. artificially generated items, (derived from the profiling generated by the learning module (No. 6) or c. a combination of real work items and generated ones (the last two options may be relevant only when used as a simulation engine).

FIG. 8 demonstrates a possible section of the User Interface where some elements of the operational model parameters can be set. The interface for hooking up to agents, both data-collectors, control agents, and third party APIs is not displayed. This may be a Graphical User Interface, or sometimes may require using Application Programming Interface.

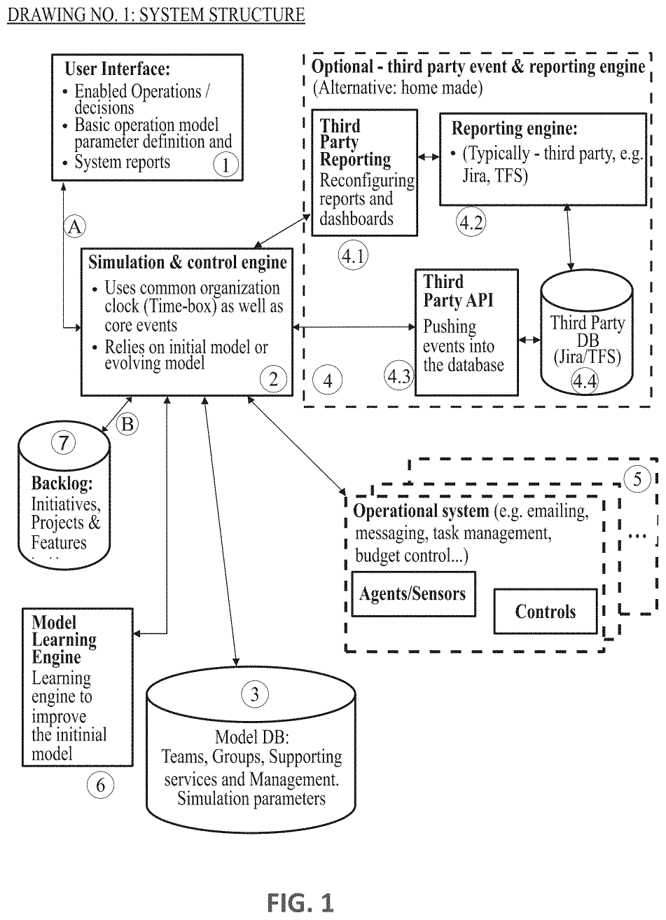

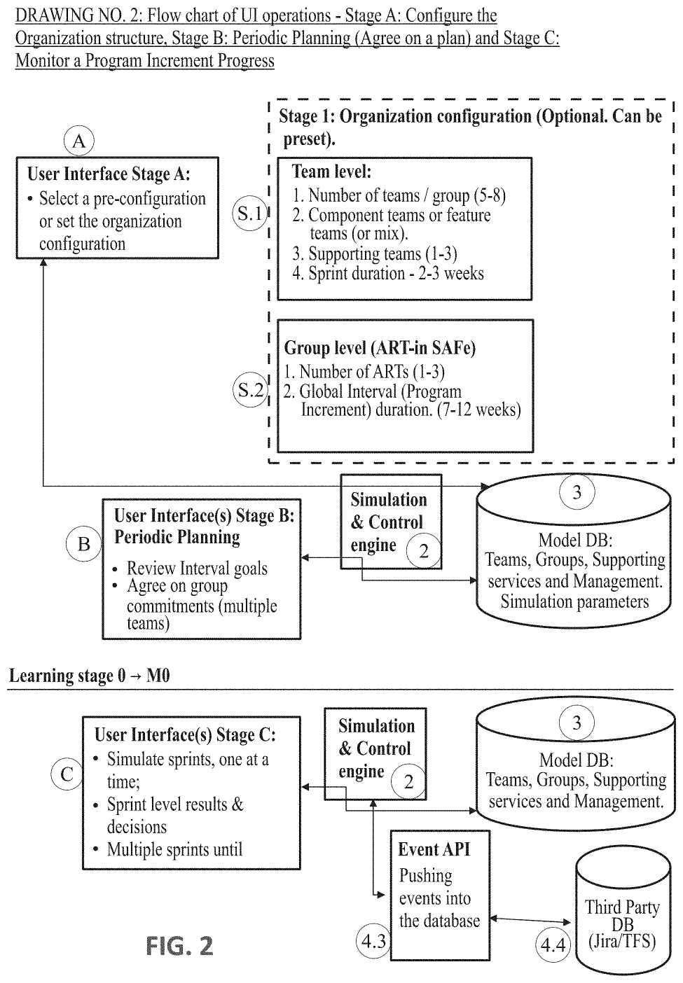

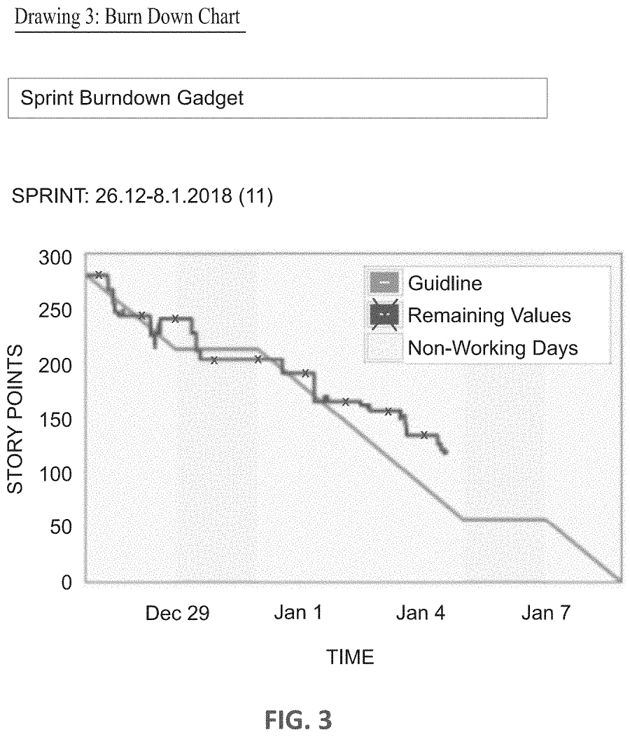

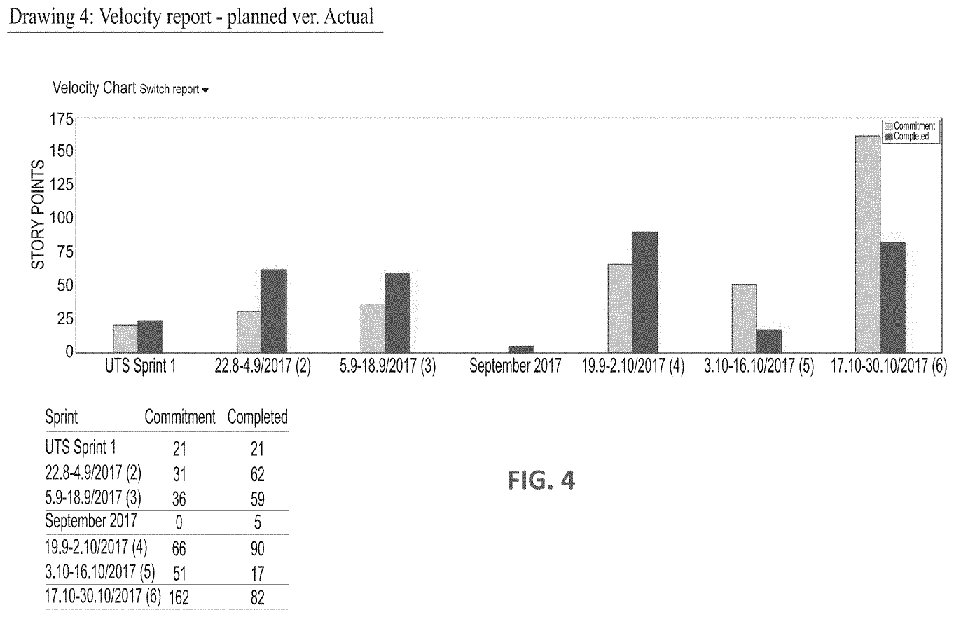

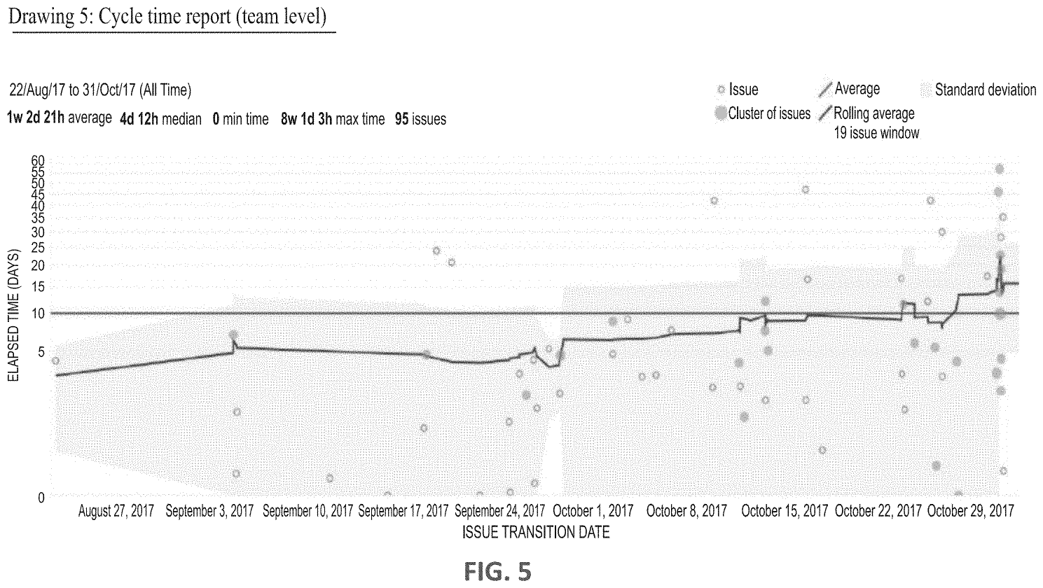

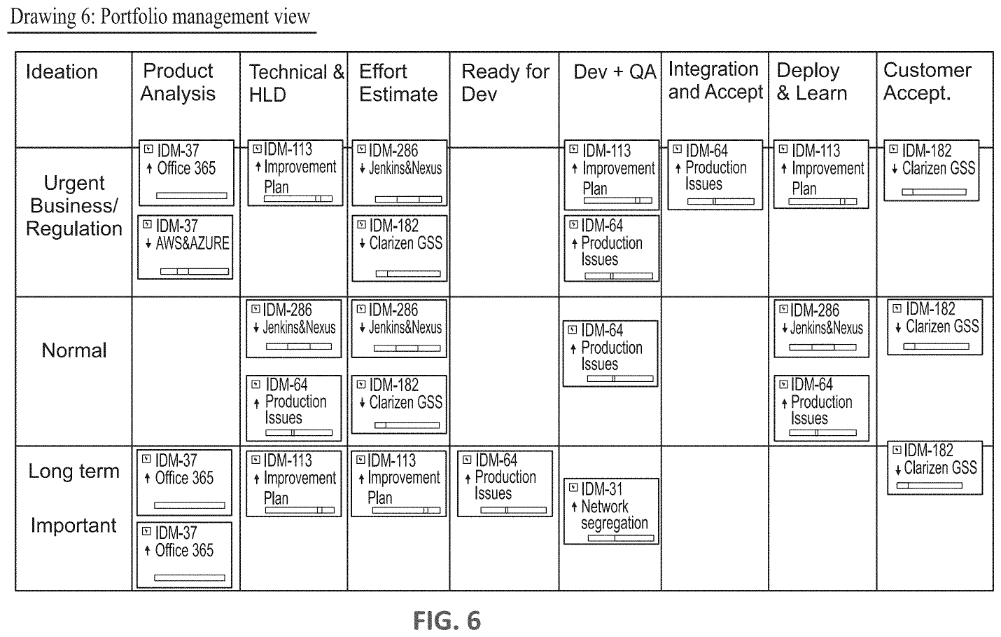

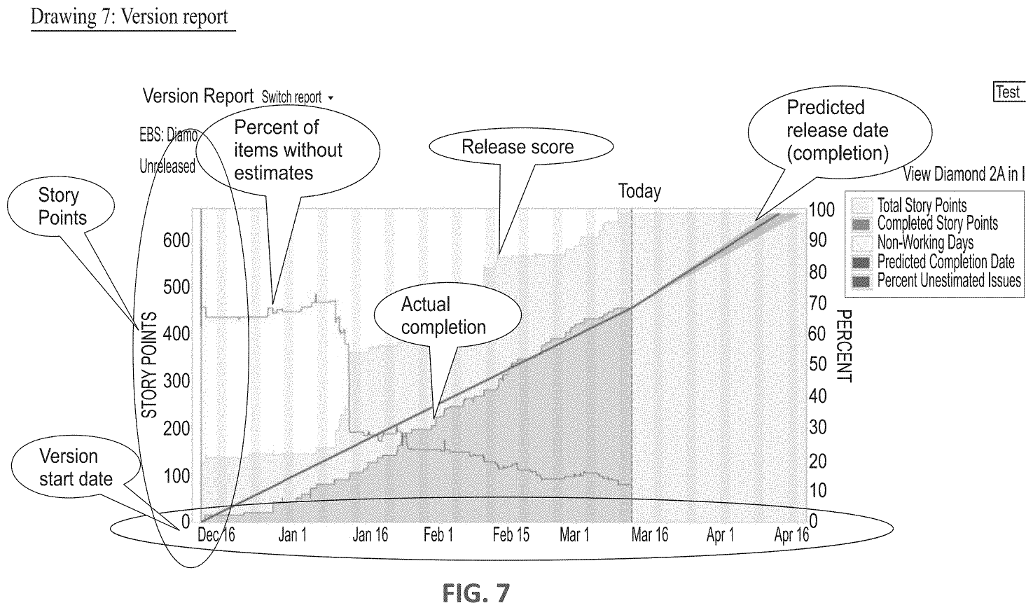

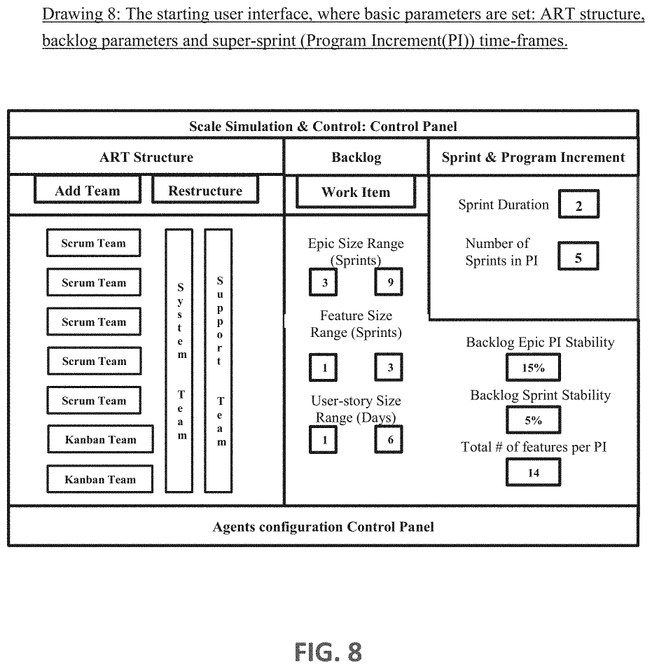

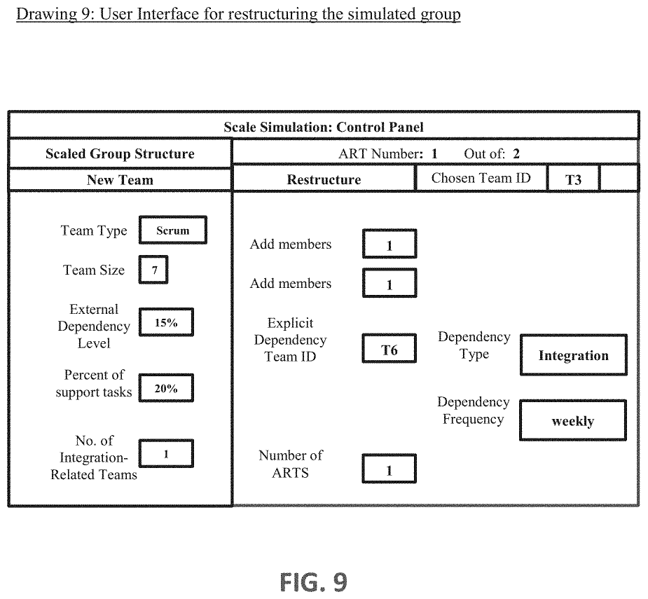

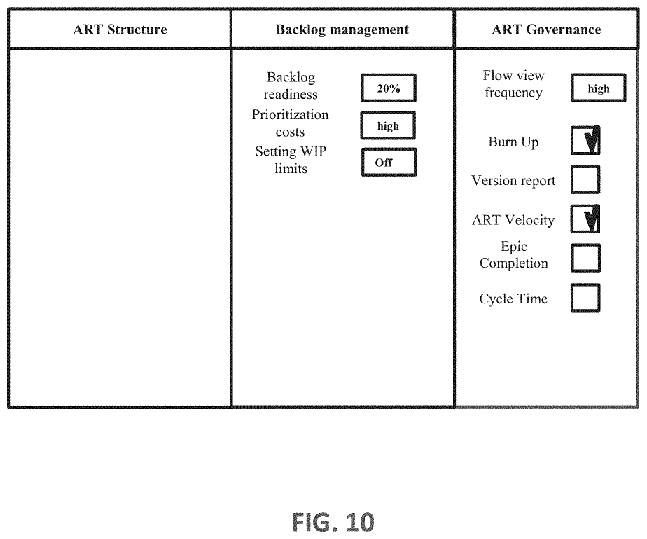

FIG. 2 provides a flow diagram to demonstrate the various stages of interaction of a user of the system, using the architecture outlined in FIG. 1. In Stage A, the user sets the system parameters. This can be done in one of several ways:
Reading from a predefined set of organizational configurations. (FIG. 1. Module 2)
Gathering the information using the API (FIG. 1 module 5)—to get the row data from the operational system or

Move to Stage B and use simulation control engine (2) and the Model DB 3 the User Interface to set the initial system parameters.

The parameters that need to be set are stated in stages S.1 and S.2—and include the team level parameters (number of teams, structure and specialization) and sprint duration. Additional parameters are at the Scaling up level: the structure of an ART, the duration of an Increment, (the super-sprint), etc.

FIG. 2 Stage C—shows the flow diagram for learning and improving the model. This uses sensors and data-source from the organization in order to improve the accuracy of the model, and to provide better prediction.

FIGS. 3, 4, 5, 6 & 7 show several specific views of a system dashboard, which is commonly used at the team level, by various task-management tools, as mentioned before. Using the API, these graphs can be created without having to explicitly program these views. Further, they can be configured to show the data for the Scaled Group, the ART.

FIG. 3 shows a standard BurnDown Chart. This graph shows the synthetic linear progress (the gray line) in contrast with the actual, fact-based graph (the red line) which shows how the work progresses. This graph is commonly used in Agile operation at the team level, but using the API of FIG. 1, Module 4.3—such a figure can be extracted for the simulator. Further, using the API, this graph can be used also for a Scaled Group.

FIG. 4 shows the ‘velocity’ of the ART—as derived from the velocity of the teams; this is a standard view in various Agile systems. It shows in grey, the amount of work (planned tasks, etc.) which was planned for a sprint, in contrast with the amount of work actually completed, shown in Green.

FIG. 5 shows the various parameters of Cycle Time, as defined in the system: this can be either a partial duration it took each task between two stages, or, preferably, the total time from initiation until deployment. The white and green circles show the cycle time of a specific task, and the day it was completed on. Green points indicate a cluster of several tasks. The blue line shows the average cycle time at a given moment. The red line shows the current average.

FIG. 6 is a typical Kanban board, showing the various work items (typically, at a high level, such a key features), each one in the relevant working stage. The board is typically configured to indicate all the stages that contribute to a complete delivery of a feature to the market.

FIG. 7 shows the actual progress and the predicted conversion time of a version, with an ongoing content added. The straight blue line is a linear approximation of the progress until “today”. The dark blue area is the accumulated completed work. The gray area represents the currently known amount of work for the version, namely, the approximated effort to complete the version content. The red line indicates the amount of tasks that were properly broken down and estimated.

This report is vital for a manager that needs to know and monitor the progress towards a planned delivery. This report allows, typically, for predicting the time-scope convergence in about a third of the time-span of the project.

FIG. 8 shows a possible configuration User Interface. Using such a UI, the user can choose the various parameters to set the control system, and accelerate the learning process.

Three sets of parameters can be defined:
1. Organization structure: The various teams, the support teams and their sizes and roles.
2. The backlog parameters, including Epic size-range, Feature size-range and User Story size-range. Further, the user can help set some control parameters about desired or measured stability at various levels
3. The time duration of sprint and Program Increment (PI).

FIG. 9 shows a zoom in UI control for more detailed definition of the organization structure. On the left part, key parameters of the team are defined, including the degree of dependency/autonomy the team has. It also includes some statistics of support tasks, reflecting the team's activity nature. The right side of the control panel allows for defining the team size, and the types of dependencies the team is usually involved in.

FIG. 10 shows the control panel used during the execution of a Program Increment. Using this panel, the user can add/remove views, or enforce management policies such as WIP Limit (Work In Progress Limit), or the cost the control system may consider when requiring re-prioritization. Or the desired degree of backlog readiness.

### DETAILED DESCRIPTION

The present invention, in some embodiments thereof, relates to and, more particularly, but not exclusively, to automatically (or semi-automatically) improve the work model of the Agile organization using a learning-model and a simulation. The system generates predictions of an outcome of the behavior of an organization going through the Agile Scaling transformation. This Agile transformation may include both a structure change, but mostly, a culture change. The simulation lets team leaders and managers observe the impact of the various decision alternatives they normally face. The current invention describes a computer program that according to embodiments of the invention, helps managers analyze, modify, control and predict, the impacts of their decisions. Further, it allows them to optimize their organization performance automatically, semi-automatically, or manually, based on recommendations derived from the system.

It will be understood that each block of the illustrations and/or block diagrams, and combinations of blocks in the flowchart illustrations and/or block diagrams, can be implemented by computer readable program instructions. Reference is now made to FIG. 1, which shows the main components of the system:
1. A user interface component (No. 1), which is possibly used by one or multiple participants in order to:
   a. Choose the system configuration parameters (teams, groups, time intervals, and organization size), as serves to construct an initial organization model M0.
   b. View requirements and challenges as generated by the system or gathered from a backlog storage (No. 7)
The user interface is also used for:
   c. indicating core decisions (degrees of freedom) that the system may have, in order to reflect the planning and synchronization prioritization considerations of the management team.
   d. Provide a dashboard that allows for gaining insight into the resulting performance and KPIs of the organization, given management decisions.
2. A simulation & control engine (No. 2) which orchestrates between:
   a. The Model DB (No. 3) which records the organization & simulation information in a database,
   b. The event recording engine (No. 4.3 and 4.4), and the reporting and dashboard tools (No. 4.1 and 4.2).
   c. The agents/sensors which monitor the operational systems (No. 5)
   d. The Model Learning Engine (No. 6)
   e. The Backlog (No. 7)
   The simulation & control engine is responsible for reading configuration data from the Model DB, prioritization information (backlog items) created by the participants in earlier stages through the UI (No. 1) and monitor, control and activate events (when used as a control system) or generate synthetic, execution-like events per team, such as “Started a Task”, “Task is Stuck” and “Completed a task”, when used as a simulation engine. These events are generated using model Mi of the organization, which may be formed as rules, representing common team behavior, task size, and cross-team dependencies (as well as dependencies on support teams).
   The events are pushed into Module No. 4, through the API for event recording. When used as a control engine, these events are also pushed into the Operational System controls. (No. 5). The simulation & Control engine may be rule based, but typical machine-learning models are not. Random parameters may be created automatically for reflecting the dynamic nature of the organization, such as unexpected/unplanned events (e.g. urgent requests, showstoppers, personnel changes, holidays, sick leaves, and the like). The rules/parameters may also reflect cross team dependencies, representing development dependencies and infrastructure/supporting teams' nature. Another set of rules/parameters represent the frequency and nature of on-going support requests from customers.
3. The Model DB (No. 3) is used to store the above parameters as well as the data elements that are required for running the simulations:
   a. Organizational structure:
      i. Number of teams per group, and (randomly selected or manually configured) size, typically in the range of 4-10 people;
      ii. Number of groups (typically 1-3)—representing a scaled organization. These groups are referenced as Agile Release Trains (ARTs, using the SAFe terminology)
      iii. Sprint duration (typically 2-3 weeks) and Longer Interval duration: typically, 4-6 Sprints (referred to as Program Increment in the SAFe terminology, or Quarter in some implementations)
      iv. Several development scenarios, for IT organization, for ERP organization and for a Product-oriented organization. Each scenario includes a variety of changing customer needs, on-going generated regulatory instructions.
4. An optional connection to a project management tool (No. 4.), such as commonly used in the Agile industry, which provides team level management, in two aspects:
   a. Recording development events (e.g. commitment per time interval, beginning task-lifecycle events etc.). These events typically refer to Sprint lifecycle events, as well as unexpected support events (Bug lifecycle).
   b. Reporting interfaces for team and ART level. These reports include at least:
      i. Team level report:
         1. Burnup and burndown (See FIG. 3)
         2. Velocity planning (See FIG. 4)
         3. Cycle time report per team—task level (See FIG. 5)
      ii. Group level reports:
         1. Portfolio view (See FIG. 6)
         2. Cycle time report per group—Epic/Feature level (Similar to FIG. 5)
         3. Version report (See FIG. 7)
         4. Impediment reports—where have things got stuck
   As most common tools provide this functionality using a standard API, the preferred embodiment of the current invention is to replace module 4 by a standard Agile Management tool.
5. A set of agents/sensors (No 5.) which monitor the various operational systems, and report back (either in real time and/or periodically) events (e.g. project X approved, or task Y completed) and/or data (e.g. average amount of approval requests from team X to manager M per day). These events and/or data are reported back to the Simulation & Control engine (Module No. 2). The engine than sends the data to the model-leaning engine (No. 6). The simulation engine updates the data in the currently applicable model, analyzes the data, and makes recommendations for the users/managers. These improvements can either (1) be reflected back to the user (via Module 1), so that user can decide whether to adopt these recommendations (e.g. a recommendation to increase capacity of team X by 2 more team members) and adjust the simulator's configuration accordingly, and/or (2) be implemented/applied automatically into the engine's model (automatic learning model)
   The Operational System (No. 5) typically has also Control agents, which are used by the organization as gate-keepers; these can initiate a process, prevent a process, or raise an alert. When used as a Control System, these agents are activated by the Simulation & Control Engine (No. 2)—to initiate, prevent, or alert the organization as needed to ensure optimal performance.
6. Model Learning Engine (No. 6)—which uses machine-learning techniques for analyzing the data collected by the sensors/agents, and continuously improve the simulator work model. This learning engine is activated periodically, typically once or twice per Time Box, to generate the next optimal model in the sequence (Mi).
7. Backlog (No. 7)—an ordered/prioritized list of work items (e.g. initiatives, features, projects, epics—different names are used in the industry . . . ) which are the tasks that the teams need to work on and deliver. The work items can be either generated and ordered by the simulator engine (No 2.), and/or created/ordered manually by the management/user (via the UI—No. 1), and/or imported from the live task/work-management system (No. 4). The user interface (No. 1) should allow the users to choose whether they prefer to use their own prioritization considerations, or use ‘best-recommendation’ of the system, or a combination. This should allow the managers to review alternative ‘what-if’ scenarios.

Reference is now made to FIG. 2, which shows three stages of the User Interface:

Stage A: Configuration

General note: The specific numbers used in this section (and this applies also to other places in the document), e.g. the number of teams, number team members in a team, number of weeks in a sprint etc.—all these numbers are just examples representing typical sizes/quantities used in the industry, and are not meant to limit the scope of the patent in any way.

The cross-service teams are common in a large organization, representing key skills and capabilities which are subject to organization policies, and are typically not fully distributed to the development teams. These often include: Database administration, Security, Infrastructure, Networking and the like (legal, risk management, networking and procurement).

The Configuration Stage happens once in the beginning of the simulation. The participants, typically, a management team, select a configuration which best describes the situation in their organization:
Configuring or loading a predefined configuration: for ease of use, the system may suggest several out-of-the-box configurations:
   A single ART (Agile Release Train)—consisting of 5-9 development teams, 2-3 system/cross-service teams, which provide services to all of the 5-7 development teams.
   Multiple ARTs (up to 3), with 5-7 cross-service teams, which are shared across all the ARTs, with various dependencies. Minor cross ARTs dependencies are generated automatically by the rule-engine.
   Component-teams versus feature-teams' configurations within each configuration may be supported as well.
The management team can manually restructure the organization to best reflect their own organization structure according to the parameters mentioned above, or to simulate the impact of a re-organization.
Additionally, the configuration includes either a synthetic (simulated-generated) backlog that the teams need to deliver. This backlog can be generated in several ways:
   a. Based on pre-detected backlog, gathered by the sensors, or explicitly gathered from a backlog database; (in both cases, the backlog is the real, organization backlog for the coming Time Box).
   b. Synthetic backlog, that matches typical organization parameters
   c. Manually insert backlog items, or
   d. A combination of synthetic backlog which is derived from the existing backlog as described in item a above, combined with “what-if” cases inserted manually.

Stage B: Program Increment (Periodic/Quarterly) Planning

Most of the Agile scaling methodologies assume that a periodic planning event takes place, which involves multiple teams. This event is the peak of a ‘pre-planning’ process in which the leadership of the group (multiple-teams) reviews the business objectives and initiatives, and turns them into a prioritized backlog. This backlog is the input for the periodic planning event. The output is an agreed plan and agreed set of common goals for the next period (time box, quarter, or PI in SAFe)

During the Periodic Planning, during Stage B, the participating team takes the common steps and decisions taken by the teams:
Review the high-level objectives or projects (sometimes at a requirement level)
Split requirements or backlog items into more detailed tasks (this is defined as backlog maturity). In reality, this is a time-consuming process, and the participating management team can choose how much to invest in this. This decision sets different parameters for the Simulation Engine. (Better prepared backlog can be faster to complete, dependencies are earlier detected, etc. . . . ) however, a balance must be found on how much to invest in improving the backlog, as it effects the ability to execute currently running tasks
Team level commitment
Cross-team commitment—this is a cultural/structural parameter, which reflects the organization structure, and the degree of internal separation—or the degree of information flow across the various contributors to a project.
Plan review and agreement.

These operations can be performed in the System UI, or externally, using the organization's preferred tools. In the latter case, the resulting Backlog may be loaded into the Backlog module (No. 7 in FIG. 1), or may be gathered by the sensors/Agents (Module 5 in FIG. 1). In FIG. 2, stage B reflects the situation that planning has taken place in the Project Management Tool (Jira/TFS), and thus the information is gathered from Module 4.

During the setup of the system, the participants can choose a “backlog scenario”. In this context, “backlog scenario” means the parameters describing the backlog: The number of work items of various types (e.g. epics, features, projects, initiatives . . . ) and/or sizes (e.g. small work items which might take a few hours/days to complete, or bigger work items which might take weeks/months to complete), and/or with various dependencies on other teams and/or on other work items, as well as the maturity of the breakdown of each work-item.

Upon completion of the initialization and data gathering stages, the system is “activated” and the learning engine builds the first Model, M0.

Upon Completion of this Stage, the System is Ready to Start, Hence, it is ‘Operational’.

In the planning stage, management may consider using past information, in order to allow for a better planning towards predictability. For example, by using the Velocity view (FIG. 4), manager can suggest how much the ART and each team should commit for in the next Program Increment. By using the Cycle Time view, managers can commit for on-going support tasks that are generated, and can anticipate when a specific feature may be completed, if it needs to be moved down the manufacturing path.

By looking at the Kanban Board (FIG. 6) managers can direct the team members where to focus, where help is needed, and the accurate priority of features and tasks.

Stage C: Simulate or Control a Program Increment.
The larger Program Interval, is comprised of several standard Agile Sprints (2-3 week each, which is the Timebox).
When running as a Control system, the system tracks events in almost real time using the agents (No. 5). Additionally, whenever necessary, an event is triggered by the Control Engine (No.2), based on the current model (Mi). This event is transmitted to the relevant Control agents in either external system (No. 4) or (No. 5).
When running in as a simulation engine the engine uses the model to simulate the progress and occurrences that typically happen during a Sprint interval. It pushes each relevant event to the Agile Management Tool API, which records the events, and updates the simulated progress status accordingly.
By default, the system is configured to stop in order to generate a snapshot at the end of each sprint, and provide the management team the various reports that are commonly used by Agile teams. Additionally, the ART level managers can review higher level reports. A sample set of such reports is shown in FIGS. 3,4,5,6 and 7.

During a simulation session, Stages B and C are repeated multiple times, representing the Program Increment Planning process (Stage B) followed by the Program Execution simulation, (Stage C). The output and actual simulation results are presented using the various dashboards mentioned above, in order to support better planning and decision making in the following Program Increment.

The two most meaningful Key Performance Indicators (KPIs) for measuring the improvement of the control/simulator are:
1. Throughput—how many work-items have been completed.
2. Predictability—compared to the plan, what percentage has been actually achieved.

At each stage of the execution, management can review a variety of dashboards. Establishing these dashboards, configuring them, and ensuring that the group generates the data required for these dashboards, are time consuming, and reflect some of the costs that management has to pay for future improvements.

Reference is now made to the model database (number 3, in FIG. 1), where the core elements of the organization parameters are stored, as well as key decisions about the implementation. This database is referred to as the Model of the organization. The model, typically, contains the following tables:
a. Organization structure:
   a. Teams, size structure & capabilities (specialized teams for support? Cross-service teams, multi-functional teams)
   b. Cross-service teams, providing typical organization services
   c. Grouping teams into larger groups, namely ARTs. Unique portion of cross-service teams which are allocated to each ART
b. Process data, Timebox:
   a. Sprint and Program increment duration
   b. Cross-service type and dependency scenarios
c. Adjusted Content
   a. Backlog for the development teams, as it evolves over Sprints & Program Intervals, adjusted to a variety of organizations/products
   b. Support requests/bugs over sprints, with specific team/component skills
   c. Randomization parameters—for bugs and dependency accuracy, past velocity of teams, holidays, etc.
d. Flow policies, either explicit or implicit: development gates, approval processes, etc. These policies typically generate delays, but are vital for ensuring quality in the processes. Often, though these policies reflect the worst-case scenario, and therefore, they are costly and time consuming. Alternatively, they can be eased down when possible. The model can reflect some of these wastes.

When used as a simulator, during the simulation stages, the system exposes events derived from the Model Database, according to the timing of these events. The management team can perform one of several actions:
a. Assign a task to a team, in mid-sprint, or for next sprint.
b. Prioritize items in the backlog or modify existing priorities
c. At Sprint end, or Program Increment boundaries, management can alter the group structure—by:
   a. Moving people between development teams
   b. Adding people to cross-service teams or moving them into teams or ARTs.
d. At Program Increment boundaries, the management team can add tasks of dashboard improvement, backlog improvement and process conformance improvements.

Obviously, the backlog items may be associated with business value, or monetary values. Similarly, each backlog item may be associated with relative effort estimate. The goal of the management team (both in simulation mode and in controller mode) can be to earn as much money as possible, or as many backlog items, during a fixed number of Program Intervals. (Note that in real life, long term goals may yield high value, and this may require low income at early Program Increments).

Further, each operation in the simulation, such as backlog refinement, or dashboard tuning, can also be associated with a cost, to reflect the effort that is required in order to improve overall performance.

As stated before, using the system the management team of large groups (50-500 people) can overcome some of the challenges that they face during an Agile transformation, or even after some experience has been gathered: the flow and the mechanics of manufacturing the backlog items are understood, but practical questions such as where to invest attention and budget, are not answered. Some of these challenges are:
1. Would adding a person to some team have a meaningful impact on the entire group's performance? Which team is that?
2. Which flow restrictions should be set, in order to improve cycle time (time-to-market)? Hence, what should the manager instruct the group to refrain from doing?
3. How much to invest in planning and prioritizing the backlog? Or is its current, imperfect, maturity sufficient?
4. How to restructure the group? Which of the common cross dependencies need to be resolved by distributing the service?
5. How much to invest in governance tools and their assimilation into the process, and when to do that?

When the control system is activated the user can use the various User-Interfaces knobs in order to control the desired focus of the execution:
By using the various views, a manager can gain ongoing understanding of the execution state.
By using the various controls, the manager can decide how may ARTs are controlled, and what is the level of flexibility is required from each ART. By using a low “Prioritization cost”—the manager indicates that reprioritization can be done only when the ART is actually flexible. By setting the backlog readiness knob, the manager can force more Grooming activity on the Product Group, etc.

During the execution of the Program Increment, the various views, specifically the Portfolio view (Kanban board FIG. 6) can be used to allocate resources for high priority items that do not progress in the desired speed, or seem to be late for the Version date (FIG. 7).

While the system can automatically generate these controls, it can also be used as a ‘decision support’ system, or as a simulator. In any case, alerts and indicators for issues during the Program Increment are directed to the relevant managers.

TERMS

| Term | Description |
|---|---|
| Agile | Id the context of this patent application, the term “Agile” is used a generic name for a family of |
| | management practices and frameworks which share common/similar values and principles, |
| | where the most popular are: Agile, Lean, Scrum, Kanban, SAFe, LeSS, DaD, etc. |
| | The Agile values and principles are documented in the Agile Manifesto |
| | (https://agilemanifesto.org/) |
| Agile Team | Ideally, 3-7 people, self-managed team, collocated, multifunctional with a common goal. See |
| | definition later. |
| ART | Agile Release Train. A SAFe term representing a big group (typically 50-125 people), which |
| | consists of several agile teams, that plans and delivers features collaboratively in a PI |
| | (Program Increment). |
| | See https://www.scaledagileframework.com/agile-release-train/ |
| Backlog | An ordered list of deliverables and/or work items (Backlog Items) that the team needs to work |
| | on, implement, and deliver. |
| | An agile team typically has a backlog associated with it, from which the team pulls work |
| | (backlog items) to work on, according to the priorities (pull items from the top of the backlog). |
| | Higher levels of the organization (e.g. program, portfolio, and the entire enterprise) may also |
| | have their own backlogs, containing the bigger projects or initiatives. |
| Backlog Item, | A generic name for any deliverable or task in the backlog. Different organizations may use |
| work item | different types of backlog items. For example, a backlog item can represent a project, an epic, |
| | a feature a user story, a technical task, or any other thing the team needs to do and/or deliver. |
| Cross-Service | See Service Team |
| Team | |
| Cycle Time | Typically represents the overall time that it takes to deliver a deliverable to the customer, from |
| | the moment the customer placed the order or the request, until the request was satisfied, or the |
| | deliverable delivered. A main goal of an agile-lean organization is to reduce the cycle time by |
| | applying agile/lean practices. |
| Interval | In this document, the term “Interval” is sometimes used a synonym for Time Box, or Sprint. |
| IT | Information Technology |
| Kanban | An agile-lean practice typically used by agile teams and by lean organizations, where work is |
| | made visible on a visual board. On the board one can see all the work items, their priorities, |
| | their states (e.g. to-do, in progress, done, blocked, canceled, . . .). Cycle time and other metrics |
| | are measured, and process is continuously improved to reduce cycle time, increase quality |
| | etc . . . |
| KPI | Key Performance Indicators |
| Large Scale | A term used to describe a process by which a big organization (e.g. >50 people) is |
| Agile | transforming from current “old” or “traditional” management practices, to agile practices, |
| transformation | mindset, and culture. |
| PI | Program Increment. |
| | See Time Box |
| | See https://www.scaledagileframework.com/program-increment/ |
| SAFe | Scaled Agile Framework (https://www.scaledagileframework.com/) - a popular framework for |
| | implementing agile practices in large organizations. |
| Scrum | A popular agile practice, where a team is working together on a set of backlog items during a |
| | Timebox called Sprint (typically 2 weeks). For the formal definition of scrum see: |
| | https://www.scrumguides.org/ |
| Service-Team | A team whose main goal is to provide some services to other teams. For example, in a big IT |
| | organization, a security team may provide a service of security reviews to the various |
| | development teams. |
| | Synonym: Cross-Service Team |
| Sprint | See Time Box |
| Team, Agile | A small group of people working together towards shared goals. The size of an agile team is |
| Team, | typically less than 10 people. Agile teams may use various agile practices, where most popular |
| Cross- | are Scrum and Kanban. |
| Functional- | Cross-Functional-Team is a team that has all the capabilities/skills inside the team, so that |
| Team, | the team can work independently and deliver the value (e.g. feature, story, new functionality) |
| Component- | to the customer. |
| Team, | A Feature-Team is an example of a cross-functional-team, where the team has all the |
| Feature-Team, | capabilities to implement and deliver a feature end to end. |
| Functional- | Component-Team is a team that is responsible for a specific component of the system (e.g. a |
| Team | team that is responsible only for the network, or only for the UI) |
| | Functional Team is a team that has only a specific skill (e.g. testing team, architecture team, |
| | technical writing team). |
| | An organization that is designed or built from component teams and/or functional teams will |
| | have lots of inter-team dependencies, which will increase complexity and will slow-down the |
| | progress (and hence increase cycle time). |
| | The more a team is cross-functional, the less dependencies it has on other teams, hence the |
| | faster it can deliver and reduced cycle time. |
| | See also Service-Team |
| Time Box | A limited period of time in which a team collaborates (work together) to try and achieve the |
| | planned goals. Sprint is an example of a time box used by scrum teams (typically 2 week). PI |
| | (Program Increment) is an example of a time box used by big teams (Agile Release Train, or |
| | ART in SAFe terminology. Typically, 4-6 sprints or quarter). |
| TTM | Time to Market |
| UI | User Interface |
| WIP | Work In Process - the number or amount of work items that are in process (as oppose to work |
| | that has not started yet, or work that has already been completed) |
| WIP Limit | A practice by which a decision is made to limit the amount or number of work items that the |
| | team is working on in parallel, to reduce context switch overhead, increase team focus, |
| | increase flow, and ultimately decrease overall cycle time. |
| Work Item | In the context of this document - a synonym for Backlog Item |

What is claimed is:

1. A computerized method for allowing trainees to generate and manage an interactive simulation comprising of:
Defining an initial organization Agile model including a backlog scenario
A simulation & control engine which shows scaled organization dashboard according to said organization model for the next Program Increment;
Where said system is used either for training the users by showing them the impact of their agile managerial decisions, or in order to predict expected behavior of the system over time. Said engine uses a learning engine in order to define the operational model, that changes the engine behavior.

2. The method of claim 1, wherein each one of said plurality of model parameter values is either defined using a User Interface or gathered from a set of sensors, or generated by a model generation tool.

3. The method of claim 1, where said dashboard is generated by a standard Agile project management tools.

4. The method of claim 1, where the simulation engine is time driven and the clock tick is a Day or a Sprint or a Program Increment interval.

5. The method of claim 1, where the simulation engine uses also pre-defined events (on top of the timing events), requiring user interaction during a Sprint, to handle managerial events during a sprint.

6. A computerized system where users need to earn business value, or equivalent “money”, by achieving (completing, delivering) as many items from the backlog, where said participants can alter organization structure, prioritize backlog items, plan, and operational parameters. Said organization structure alterations include:
Defining multiple teams
Defining multiple ARTs (Groups)
Moving people into, or out of, teams and ARTs
Modifying team structures in order to reduce cross team dependencies
Said prioritization backlog activities include:
Different prioritization of given backlog
Setting concurrency limits on backlog execution (reducing WIP limit)
Investing more budget/effort in preparation of backlog
Where the said system is geared to provide various scenarios for the participants to commit and deliver as many work items from the backlog.

7. A learning work model which automatically improves the organization work model based on data collected by sensors/agents from the various organization's operational systems.

8. The method of claim 7, where the base work model is configured by the user, and subsequently evolves and improves automatically based on learning and/or manually based on user inputs. Where an improved model can ensure higher throughput of backlog items per Timebox.

9. The method of claim 7, where the sensors/agents collect data from one or more of the following types of operational systems:
work/task-management system—information on work items, their characteristics (type, size,) and status (including status history e.g. when the item was created, who and when started to work on it etc.—until the end of the item's life-cycle), team structure, and time-boxes.
finance/budget-control system—information of budget approval/allocation events
mailing system and/or other communication/messaging systems—information on types, frequency/intensity of communication links between people and/or various parts of the organizations (organization units).

10. The method of claim 7, where the following aspects of the work model evolve and improve over time via learning based on data collected by the sensors:
team/organization structure—increase/decrease team capacity, unify teams
Altering the WIP-limit—set or fine-tune the WIP (Work-In-Process) limit for teams and/or for various stages in the process.
Eliminate or reduce waiting time in the process by removing or decreasing the time required for various types of approvals
Eliminate or reduce dependencies on other teams (e.g. on shared-services) up-skilling a team to perform additional types of activities, previously provided by other teams.
Said improved model results in higher throughput and/or higher predictability.

11. A computerized method for automatic continuous process improvement comprising of:
Mapping the initial scaling Agile organization model (team structures and durations)
Automatic application of the learning model recommendations in the organization's operational systems.
Where said computerized method automatically controls the operational systems of the organizations, (feedback loop).

12. The method of claim 11, where the initial scaling model is generated automatically by exporting the team structure, durations, and other process parameters from the operational task/work management systems.

13. The method of claim 11, where a base-line metrics is established which refer to (a) amount of work planned per team/group per time-box (b) average amount of work each team/group manages to complete per time-box (c) average cycle time per types of work items.

14. The method of claim 11, where the organization's operational systems refer to at least (a) the system(s) where the teams structure is defined, (b) the system(s) where the sprint/Program Increment/Timebox plans are defined for the various teams, (c) the system(s) where process flow parameters are defined or monitored.

15. The method of claim 11, where the learning model recommendations refer to (a) limiting the amount of planned work per team/group per time box, (b) change (increase or decrease) WIP Limits for various process states or (c) adding some work items per team/group for a given time-box.

16. The method of claim 11, where automatic feedback loops contain one or more of the following: (a) collecting measurements from the task/work management system during and at the end of time-boxes, (b) comparing to previous measurements and analyzing trends, (c) determine the degree of improvement achieved compared to previous time box, (d) report back to the learning model so that it can fine-tune the model and its next recommendations based on the new measurements and the amount of improvements achieved (e) automatically controlling the task/work management systems during the operation of the next time-box to enforce new model's constraints.
